(19) United States
(12) Patent Application Publication
(10) Pub. No.: US 2012/0307395 A1
(43) Pub. Date: Dec. 6, 2012

(54) PERPENDICULAR MAGNETIC RECORDING MEDIUM WITH AN INVERTED Hk STRUCTURE

(75) Inventors: Shun Tonooka, Odawara (JP); Kiwamu Tanahashi, Tokyo (JP); Hiroyuki Nakagawa, Yokohama (JP); Ichiro Tamai, Odawara (JP)

(73) Assignee: Hitachi Global Storage Technologies Netherlands B.V., Amsterdam (NL)

(21) Appl. No.: 13/149,780

(22) Filed: May 31, 2011

(51) Int. Cl. G11B 21/02; G11B 5/667; G11B 5/66

(52) U.S. Cl. 360/75; 428/827; 428/828.1; G9B/21.003

(57) ABSTRACT

According to one embodiment, a perpendicular magnetic recording medium includes a first granular recording layer characterized by a magnetic anisotropy Ku₁, a second granular recording layer above the first granular recording layer characterized by a magnetic anisotropy Ku₂, and a third granular recording layer above the second granular recording layer characterized by a magnetic anisotropy Ku₃, wherein Ku₃<Ku₂>Ku₁. In another embodiment, a magnetic medium includes a first recording layer with a first CoCrPt alloy in a first ratio X₁, a second recording layer above the first recording layer and having a second CoCrPt alloy in a second ratio X₂, and a third recording layer above the second recording layer having a third CoCrPt alloy in a third ratio X₃ with each ratio defined as a concentration of Pt divided by a concentration of Cr in the respective CoCrPt alloy, wherein X₃<X₂>X₁.

### FIELD OF THE INVENTION

The present invention relates to a perpendicular magnetic recording medium, and particularly to a perpendicular magnetic medium which allows a large volume of information to be recorded having an inverted Hk structure, and to a magnetic storage device employing the same.

### BACKGROUND

In order to increase the capacity of magnetic recording devices it is advantageous to enhance the performance of the perpendicular magnetic recording media by improving the writeability and the signal-to-noise ratio (SNR), while maintaining the thermal stability of magnetized information (magnetic recording bits). Currently, many perpendicular magnetic recording media which are commercially supplied have a layered structure comprising a granular recording layer which contains oxide and has a granular structure, and a ferromagnetic metal layer which does not contain oxide and does not have a clear granular structure, as disclosed in Japanese Unexamined Patent Application Publication Nos. 2001-23144, 2003-91808, and 2003-168207, for example. The ferromagnetic metal layer is formed from a material having a relatively low magnetic anisotropy and therefore has a small switching field and serves to improve writeability. The granular recording layer is formed from a material having high magnetic anisotropy and therefore serves to improve the thermal stability. In addition, the granular recording layer also serves to reduce the magnetic cluster size and to reduce noise. The granular recording layer is typically formed from a material in which nonmagnetic compounds, such as oxides and nitrides, are mixed with a CoCrPt alloy. In this layer, magnetic grains, which are mainly formed by Co atoms, are surrounded by non-magnetic Cr-oxide and/or other added oxides or nitrides. As a result, the magnetic cluster size is reduced, and therefore the noise is reduced. By combining the granular recording layer and the ferromagnetic metal layer in this way, it is possible to achieve high writeability and a high SNR while maintaining the thermal stability.

If the magnetic anisotropy of the granular recording layer has a gradation in such a way that the value becomes smaller toward the upper layer, the incoherent rotation mode of the magnetic moment is promoted, and this sometimes makes it possible to further improve the writeability.

Japanese Unexamined Patent Application Publication Nos. 2009-187597 and 2009-11060, for example, disclose recording media in which a lower granular recording layer formed on a substrate side is formed from a magnetic alloy having a relatively high magnetic anisotropy, and, in succession, an exchange coupling control layer is formed thereon, a granular recording layer having relatively low magnetic anisotropy is formed thereon, and a ferromagnetic metal layer formed from a non-granular material is formed thereon. If the granular recording layer has a gradation such that the magnetic anisotropy becomes smaller toward the upper layer, the incoherent rotation mode is promoted, and the writeability is improved. Furthermore, Japanese Unexamined Patent Application Publication No. 2009-59402 also discloses a similar kind of configuration. A granular recording layer having a low magnetic anisotropy is formed directly under the ferromagnetic metal layer in order to suppress the problem of the magnetic transition width enlarging. It is disclosed that as a result, the SNR and resolution may be improved. Furthermore, K. Tanahashi, H. Nakagawa, R. Arai, H. Kashiwase, H. Nemoto, “Dual Segregand Perpendicular Recording Media With Graded Properties, IEEE Trans. Magn. 45 (2009) 799, discloses a configuration in which the granular layer is formed by a two- or three-layer structure, and the magnetic anisotropy becomes smaller in stages toward the upper layer. It is disclosed that this configuration promotes an incoherent rotation mode, and therefore it is possible to reduce the film thickness of the ferromagnetic metal layer while maintaining writeability. The reduction of the film thickness of the ferromagnetic metal layer reduces the magnetic cluster size, and therefore the SNR and ATI (adjacent track interference) characteristics may be improved.

### SUMMARY

According to one embodiment, a perpendicular magnetic recording medium includes a first granular recording layer having a magnetic anisotropy Ku₁, a second granular recording layer above the first granular recording layer having a magnetic anisotropy Ku₂, and a third granular recording layer above the second granular recording layer having a magnetic anisotropy Ku₃, where the respective magnetic anisotropies have a mathematical relationship wherein Ku₃<Ku₂>Ku₁.

In another embodiment, a perpendicular magnetic recording medium includes a first granular recording layer with a first CoCrPt alloy in a first ratio X₁, defined as a concentration of Pt divided by a concentration of Cr in the first CoCrPt alloy, a second granular recording layer above the first granular recording layer and having a second CoCrPt alloy in a second ratio X₂, defined as a concentration of Pt divided by a concentration of Cr in the second CoCrPt alloy, and a third granular recording layer above the second granular recording layer and having a third CoCrPt alloy in a third ratio X₃ defined as a concentration of Pt divided by a concentration of Cr in the third CoCrPt alloy, wherein the respective ratios adhere to a mathematical relationship X₃<X₂>X₁.

In yet another embodiment, a perpendicular magnetic recording medium includes a first granular recording layer, a second granular recording layer above the first granular recording layer, an exchange coupling control layer above the second granular recording layer and a third granular recording layer above the exchange coupling control layer, wherein the exchange coupling control layer has a saturation magnetization of no greater than about 300 emu/cc.

Any of these embodiments may be implemented in a magnetic data storage system such as a disk drive system, which may include a magnetic head, a drive mechanism for passing a magnetic storage medium (e.g., hard disk) over the head, and a control unit electrically coupled to the head for controlling operation of the head.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a cross-sectional schematic diagram of a perpendicular magnetic recording medium according to one exemplary embodiment.

FIG. 2 shows a relationship between the concentration ratio X of Pt and Cr, and magnetic anisotropy Kᵤ.

FIG. 3 shows a relationship between the film thickness of the layer in which Kᵤ is highest, and KᵤV/K_{B}T.

FIG. 4 shows a relationship between resolution and KᵤV/K_{B}T, when the concentration ratio X of Pt and Cr is varied.

FIG. 5 shows a relationship between overwrite and KᵤV/K_{B}T, when the concentration ratio X of Pt and Cr is varied.

FIG. 6 shows a relationship between SNR and KᵤV/K_{B}T, when the concentration ratio X of Pt and Cr is varied.

FIG. 7 shows a relationship between Cr concentration in the first granular recording layer and SNR.

FIG. 8 shows a relationship between Cr concentration in the first granular recording layer and KᵤV/K_{B}T.

FIG. 9 is a cross-sectional schematic of a perpendicular magnetic recording medium according to one exemplary embodiment.

FIGS. 10A and 10B are cross-sectional schematics of a magnetic recording device according to one exemplary embodiment.

FIG. 11 is a schematic showing a relationship between the magnetic head and the magnetic recording medium.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

According to one general embodiment, a perpendicular magnetic recording medium includes a first granular recording layer having a magnetic anisotropy Ku₁, a second granular recording layer above the first granular recording layer having a magnetic anisotropy Ku₂, and a third granular recording layer above the second granular recording layer having a magnetic anisotropy Ku₃, where the respective magnetic anisotropies have a mathematical relationship wherein Ku₃<Ku₂>Ku₁.

In another general embodiment, a perpendicular magnetic recording medium includes a first granular recording layer with a first CoCrPt alloy in a first ratio X₁, defined as a concentration of Pt divided by a concentration of Cr in the first CoCrPt alloy, a second granular recording layer above the first granular recording layer and having a second CoCrPt alloy in a second ratio X₂, defined as a concentration of Pt divided by a concentration of Cr in the second CoCrPt alloy, and a third granular recording layer above the second granular recording layer and having a third CoCrPt alloy in a third ratio X₃ defined as a concentration of Pt divided by a concentration of Cr in the third CoCrPt alloy, wherein the respective ratios adhere to a mathematical relationship X₃<X₂>X₁.

In yet another general embodiment, a perpendicular magnetic recording medium includes a first granular recording layer, a second granular recording layer above the first granular recording layer, an exchange coupling control layer above the second granular recording layer and a third granular recording layer above the exchange coupling control layer, wherein the exchange coupling control layer has a saturation magnetization of no greater than about 300 emu/cc.

To enhance the recording density of a perpendicular magnetic recording medium, high linear density recording patterns may be clearly written and retained in the medium. Accordingly, improvement of the resolution of the recording patterns is important. One method for achieving this involves reducing the magnetic cluster size, according to one embodiment. This is because the magnetic transition width is narrowed if the magnetic cluster size is reduced, and therefore high linear density recording patterns become possible. For example, it is possible to reduce the magnetic cluster size by increasing the oxide content of a CoCrPt alloy in a granular recording layer and physically enlarging the magnetic grain boundary width, in one approach. However, if the amount of oxide is excessive, oxide penetrates to the interior of the magnetic grains (magnetic grain core) which, as a result, may cause a deterioration in the magnetic anisotropy of the magnetic grains and an increase in the switching field distribution, so the signal-to-noise ratio (SNR) deteriorates. This means that there is a limit to improving the resolution by changes to the alloy composition and the oxide content.

Another effective and promising method for improving the resolution of the magnetic recording media involves using a thinner recording layer. If the recording layer thickness is reduced, the effective field intensity and the field gradient from the magnetic head received by the recording layer increases, and the magnetic transition width may be reduced, in one approach. Consequently, a high linear recording density pattern becomes clear and the resolution is improved. However, if the recording layer thickness is reduced (thinned) via simple scaling, the thermal stability deteriorates because the magnetic volume decreases. The relationship between the thermal stability and the film thickness in the recording layer is that of a trade-off.

According to one embodiment, a perpendicular magnetic recording medium in which the recording layer film thickness is reduced while maintaining thermal stability is possible, and a high resolution and a high signal-to-noise ratio (SNR) is realized. In another embodiment, a method for producing the perpendicular magnetic recording medium described above is provided, along with a magnetic recording device employing the perpendicular magnetic recording medium described above.

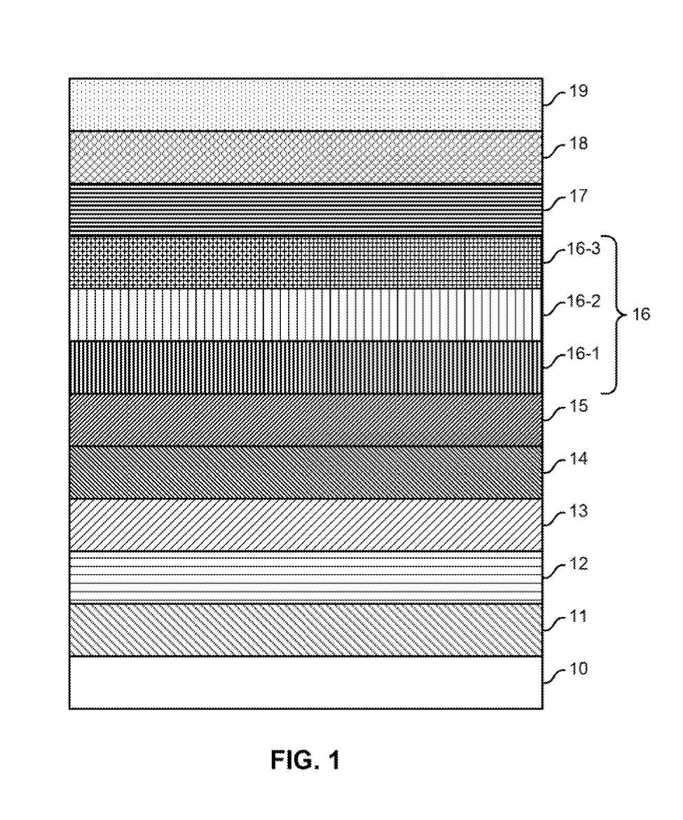

FIG. 1 shows a structure of a perpendicular magnetic recording medium according to one exemplary embodiment. In this perpendicular magnetic recording medium, the following layers are formed in succession on a substrate 10: an adhesion layer 11, a soft magnetic underlayer 12, a seed layer 13, a first interlayer (first intermediate layer) 14, and a second interlayer 15. A granular recording layer 16 and a ferromagnetic metal recording layer 17 are formed in succession thereon as recording layers, and an overcoat layer 18 and a lubricant layer 19 are formed in succession thereon. Among these layers, the method for constructing the granular recording layer 16 is a feature of particular interest in this perpendicular magnetic recording medium, while there is no particular limitation as to the materials and construction methods for the other layers, provided that they are formed as would be understood by one of skill in the art upon reading the present descriptions.

The granular recording layer 16 is formed from a magnetic alloy in which the main components are Co, Cr and Pt and includes an oxide, in one approach. Specifically, the magnetic alloy may include a Co—Cr—Pt alloy, Co—Cr—Pt—B alloy, Co—Cr—Pt—Mo alloy, Co—Cr—Pt—Nb alloy, Co—Cr—Pt—Ta alloy, Co—Cr—Pt—Ni alloy, Co—Cr—Pt—Ru alloy, etc., and also one or more from among oxides of Si, Ti, Ta, Nb, B; W, and Cr, etc. A first granular recording layer 16-1, a second granular recording layer 16-2, and a third granular recording layer 16-3 are formed in succession from the substrate side. The first granular recording layer is formed, at least partially to promote thermal stability and segregation among magnetic grains in the second granular recording layer. The second granular recording layer is the main recording layer and is formed, at least partially, to improve thermal stability, reduce the magnetic cluster size, and reduce noise. The third granular recording layer is formed, at least partially, to effectively transmit the switching torque from the ferromagnetic metal layer 17 to the second granular recording layer, promoting incoherent rotation of magnetization, and improving writeability, in various embodiments.

This perpendicular magnetic recording medium is characterized in that the following relationships are satisfied among the magnetic anisotropy Ku₁ of the first granular recording layer, the magnetic anisotropy Ku₂ of the second granular recording layer, and the magnetic anisotropy Ku₃ of the third granular recording layer.

Ku₂>Ku₁, Ku₂>Ku₃ Expression 1

The reason why Ku₂ is greatest, in one embodiment, can be explained as follows. Two adjacent layers generally undergo exchange interaction through the magnetic moment present at the interface of these two adjacent layers. By way of exchange interaction, a layer having high magnetic anisotropy (Ku) suppresses thermal agitation in the magnetic moment present in an adjacent layer having low magnetic anisotropy Ku. The thermal stability of the film as a whole is improved the greater the number of layers in contact with the layer having the highest Ku. As a result, it is possible to reduce the film thickness of the granular recording layer while maintaining thermal stability. As can be understood from the above, positioning the layer having the highest Ku in the center of the granular layer helps to reduce the film thickness of the granular recording layer.

The reason why the magnetic anisotropy Ku₁ of the first granular recording layer is smaller than the magnetic anisotropy Ku₂ of the second granular recording layer can be explained as follows. When it is only improved thermal stability which is being considered, a greater Ku₁ results in a greater improvement. However, the section at the bottom-most layer of the granular recording layer is distant from the write head, and therefore the head field intensity sharply decreases. This means that if Ku₁ is too great, the magnetic moment of the first granular recording layer cannot be switched by the head field, and hence the writeability deteriorates considerably. On the other hand, if Ku₁ is set at less than Ku₂, there is no large deterioration in the writeability. This is because, in this case, if the magnetic moment of the second granular recording layer switches (rotates), the magnetic moment of the first granular recording layer can also switch (rotate). It is therefore useful for Ku₁ to be in a range of values which are less than Ku₂ and to be appropriately set so as to match the head with which it is used. On the other hand, the saturation magnetization (magnetization saturation moment) (Ms) of the first granular recording layer preferably is not excessively large from a point of view of restricting noise. Regions where the grain boundary is unclear are present in the initial growth region of the granular recording layer in contact with the interlayer 15. In the regions where the grain boundary is unclear, the magnetic grains are magnetically coupled, and therefore the magnetic cluster size increases if Ms is large. Noise increases as a result. Accordingly, the Ms of the first granular recording layer is preferably smaller than the Ms of the second granular recording layer which is the main recording layer. This condition is also consistent with Expression 1, above. This is because if the Ms is reduced with a CoCrPt alloy, Ku is also reduced at the same time.

The reason why Ku₃ is to be smaller than Ku₂, in some embodiments, may be explained as follows. The ferromagnetic metal layer is generally formed from a material having far lower magnetic anisotropy than the granular recording layer in order to maintain the writeability. If a layer having a large Ku is used as the third granular recording layer, the difference in Ku of the ferromagnetic metal layer and the granular recording layer becomes excessive, and the switching torque from the ferromagnetic metal layer is no longer effectively transmitted to the granular recording layer below. As a result, the incoherent rotation mode of switching is suppressed, and therefore the writeability deteriorates. Accordingly, Ku₃ is to be set smaller than Ku₂ in order to achieve adequate writeability, in some embodiments.

It is understood from the above that if Ku in each granular layer is set in such a way that Expression 1 is satisfied, it is possible to improve the trade-off relationship between improved thermal stability and reduced film thickness in the recording layer with keeping thermal stability. With most conventional perpendicular magnetic recording media in which the granular recording layer has a three-layer structure, the magnetic anisotropy has a relationship where Ku₁>Ku₂>Ku₃. In this case, there is one layer which is adjacent to the layer having the highest Ku, and therefore the effect of improving thermal stability is not great. Consequently, if the film thickness of the granular recording layer is reduced, thermal stability deteriorates and adequate performance cannot be achieved.

According to one embodiment, a perpendicular magnetic recording medium includes a first granular recording layer having a magnetic anisotropy (Ku₁), a second granular recording layer above the first granular recording layer, the second granular recording layer having a magnetic anisotropy (Ku₂), and a third granular recording layer above the second granular recording layer, the third granular recording layer having a magnetic anisotropy (Ku₃), wherein Ku₃<Ku_{2l >Ku}₁.

In one embodiment, the perpendicular magnetic recording medium may be characterized by having ratios such that Ku₃<Ku₁.

In another embodiment, the perpendicular magnetic recording medium may further include an interlayer (including the first and second interlayers 14, 15) below the first granular recording layer 16-1, a soft magnetic underlayer 12 below the interlayer, and a ferromagnetic metal layer 17 above the third granular recording layer. According to a further embodiment, the interlayer may include a first interlayer 14 positioned above the soft magnetic underlayer and a second interlayer 15 positioned above the first interlayer.

In one approach, the ferromagnetic metal layer 17 may be positioned directly on the third granular recording layer 16-3. The ferromagnetic metal layer may be essentially free of oxides (of any type known in the art, within reasonable limitations) and the first granular recording layer, the second granular recording layer, and the third granular recording layer may each comprise an oxide, of any type known in the art and in concentrations as described herein according to various embodiments.

In addition to the above described embodiments, it is possible to adjust Ku in a CoCrPt alloy by adjusting a concentration ratio of Cr and Pt in a CoCrPt alloy.

X=(Pt concentration)/(Cr concentration) Expression 2

Specifically, as defined in Expression 2 above, X is a ratio of concentrations of Pt versus Cr in a CoCrPt alloy. It was discovered that the value of Ku and X are directly proportional. Accordingly, Expression 1, which represents one feature of a perpendicular magnetic recording medium, may be expressed in the following manner using the Pt and Cr concentration ratio X₁ in the first granular recording layer, the Pt and Cr concentration ratio X₂ in the second granular recording layer, and the Pt and Cr concentration ratio X₃ in the third granular recording layer, as follows.

X₂>X₁; X₂>X₃ Expression 3

In addition, the first granular recording layer may be formed to magnetically separate among the magnetic grains, and therefore the Cr content thereof is preferably at least about 18 at. %. Cr atoms included in the granular recording layer are oxidized to form Cr oxides, the magnetic grains are segregated, and the magnetic coupling between the magnetic grains splits. However, if the Cr concentration is about 18 at. % or less, the magnetic coupling between magnetic grains becomes too great, and therefore noise increases. The second granular recording layer preferably has magnetic anisotropy of around 5.0×10⁶ erg/cc or greater, although this depends on the combination with the head. To this end, X₂ may be preferably set to around 1.0 or greater, in one approach. If X₂ is below about 1.0, adequate thermal stability may not be achieved, and the magnetic cluster size also increases, causing increased noise. The film thickness of the second granular recording layer may be preferably set at between approximately 2.5 nm and about 5.5 nm in one approach, although this depends on the Ku of the alloy forming this layer and the combination with the head. If it is less than about 2.5 nm in thickness is used, adequate thermal stability may not be achieved, while if it is greater than about 5.5 nm in one approach, the writeability may deteriorate.

When the field intensity of the head which is used in the magnetic recording system is small and the writeability is inadequate, an exchange interaction control layer, having a thickness of about 1 nm in one approach, may be inserted between the second granular recording layer and the third granular recording layer. Of course, any thickness may be used as would be understood by one of skill in the art, such as about 0.75 nm, 1.25 nm, 1.5 nm, 2 nm, etc. This layer makes it possible to promote the incoherent rotation mode and to improve the writeability as a result, by providing suitable exchange interactions between the second granular recording layer and the third granular recording layer. The saturation magnetization of the exchange coupling control layer is preferably no greater than about 250 emu/cc, about 300 emu/cc, about 350 emu/cc, about 400 emu/cc, etc. If the saturation magnetization is greater than about 300 emu/cc, the exchange interactions between the second granular recording layer and the third granular recording layer may be too strong, and the effect of improving the writeability may not be provided.

There is no restriction as to the material of the exchange coupling control layer provided that the saturation magnetization thereof is no greater than about 300 emu/cc and provided that it is inserted for the purpose of controlling the exchange coupling of the third granular recording layer and the second granular recording layer; however, it may preferably be a granular material including a Co—Cr—Pt alloy, Co—Cr—Pt—B alloy, Co—Cr—Pt—Mo alloy, Co—Cr—Pt—Nb alloy, Co—Cr—Pt—Ta alloy, Co—Cr—Pt—Ni alloy, Co—Cr—Pt—Ru alloy, etc., and also one or more from among oxides of Si, Ti, Ta, Nb, B, W, and Cr, etc. Furthermore, the Cr concentration may more preferably be about 25 at. % or greater, about 30 at. % or greater, about 35 at. % or greater, etc., in order to keep the saturation magnetization of the exchange coupling control layer at no greater than about 300 emu/cc.

According to another embodiment, a perpendicular magnetic recording medium may include a first granular recording layer comprising a first CoCrPt alloy in a first ratio (X₁, defined by a concentration of Pt divided by a concentration of Cr in the first CoCrPt alloy), a second granular recording layer above the first granular recording layer, the second granular recording layer comprising a second CoCrPt alloy in a second ratio (X₂, defined by a concentration of Pt divided by a concentration of Cr in the second CoCrPt alloy) and a third granular recording layer above the second granular recording layer, the second granular recording layer comprising a third CoCrPt alloy in a third ratio (X₃, defined by a concentration of Pt divided by a concentration of Cr in the third CoCrPt alloy), wherein X₃<X₂>X₁.

In another embodiment, the perpendicular magnetic recording medium may be characterized by having ratios such that X₃<X₁.

According to another embodiment, the Cr concentration in the first granular recording layer may be between about 18 at. % and about 30 at. %, between about 21 at. % and about 27 at. %, between about 20 at. % and about 25 at. %, etc.

In still another embodiment, the perpendicular magnetic recording medium may further include an interlayer below the first granular recording layer, a soft magnetic underlayer below the interlayer, and a ferromagnetic metal layer above the third granular recording layer. In a further embodiment, the interlayer may include a first interlayer above the soft magnetic underlayer and a second interlayer above the first interlayer:

In another embodiment, a perpendicular magnetic recording medium includes a first granular recording layer, a second granular recording layer above the first granular recording layer, an exchange coupling control layer above the second granular recording layer and a third granular recording layer above the exchange coupling control layer, where the exchange coupling control layer has a saturation magnetization of no greater than about 300 emu/cc.

In one approach, the perpendicular magnetic recording medium may have a Cr concentration in the exchange coupling control layer of at least about 25 at. %, at least about 30 at. %, in a range from about 20 at. % to about 50 at. %, etc.

In another embodiment, a perpendicular magnetic recording medium as described above in any embodiment may have a first granular recording layer with a magnetic anisotropy (Ku₁), a second granular recording layer with a magnetic anisotropy (Ku₂), and a third granular recording layer with a magnetic anisotropy (Ku₃). Furthermore, each layer's magnetic anisotropy may be comparatively described by the relationship were Ku₃<Ku₂>Ku₁, and further still, in some arrangements by a relationship where Ku₃<Ku₁.

A preferred embodiment of the perpendicular magnetic recording medium is described below with respect to elements other than the granular recording layer. Various kinds of substrates may be used for the substrate 10, such as a glass substrate, an aluminum alloy substrate, a plastic substrate, a silicon substrate, etc.

There is no particular restriction as to the material of the adhesion layer 11 provided that it adheres well to the substrate 10 and has excellent planarity, but it may preferably include a material comprising at least two materials selected from: Ni, Co, Al, Ti, Cr, Zr, Ta and Nb. Specifically, it is possible to use TiAl, NiTa, TiCr, AlCr, NiTaZr, CoNbZr, TiAlCr, NiAlTi and CoAlTi, among others. The film thickness is preferably in a range from about 2 nm to about 40 nm. If it is less than about 2 nm, the effect as an adhesion layer may be impaired, and there is no improvement in performance as an adhesion layer even if it is formed to greater than about 40 nm, so the returns are diminished and since this would reduce productivity, it is undesirable.

The soft magnetic underlayer 12 serves to control the expansion of the magnetic field produced by the magnetic head and to magnetize the recording layer 16 effectively. There is no particular restriction as to the material of the soft magnetic underlayer provided that the saturation flux density (Bs) thereof is at least about 1 Tesla or greater, uniaxial anisotropy is imparted in the radial direction of the disk substrate, the coercive force measured in the head travel direction is no greater than about 2.4 kA/m, and the surface planarity is excellent, in one approach.

Specifically, the characteristics mentioned above may be readily obtained by using an amorphous alloy in which Co or Fe is the main component and Ta, Nb, Zr, B, Cr, etc., are added thereto. The optimum film thickness value varies according to a distance from the soft magnetic underlayer 12 to the recording layer 16 and the material, and also the magnetic head with which the medium is used, but a range of about 20 nm to about 100 nm may preferably be used, in one approach. Furthermore, it is also possible to use an alloy having an fcc structure for part of the soft magnetic underlayer 12. This is formed for the purpose of controlling the crystal orientation of the seed layer 13 formed above the soft magnetic underlayer 12, and specifically it is possible to use a material in which Ta, Nb, W, B, V, etc., are added to CoFe, in various approaches. The film thickness may preferably be in a range from about 1 nm to about 10 nm, in one approach. The seed layer 13 serves to control the crystal orientation of the interlayer 14 and the grain size, in one approach. For this it is possible to use a metal having an fcc structure or an amorphous material. Specific materials having an fcc structure include Ni, Cu, Pd, Pt, etc., and favorable crystal orientation is achieved by adding one or more elements selected from Cr, W, V, Mo, Ta and Nb, among others.

Furthermore, a similar action to that of the soft magnetic underlayer can be imparted by using a magnetic material which also has an fcc structure at the same time, and it is possible to reduce the distance between the magnetic head and the soft magnetic layer. Specifically, 10 at. % or less of Ta, W, Nb, Cr, B, etc., may be added to the NiFe or CoFe in the composition having the fcc structure, in one approach. An optimum film thickness value of the seed layer varies according to the material and film thickness of the interlayers and the recording layer, and the head, but a range of about 2 nm to about 10 nm may be used, in some approaches. If it is less than about 2 nm, the crystal orientation may deteriorate, which is undesirable. If it is greater than about 10 nm, the crystal grain size in the recording layer may increase, which is also undesirable. In addition, if the crystal grain size in the recording layer is to be reduced, it is possible to use an amorphous material. Specifically, such materials include Ta, TiAl, CrTi, NiTa, etc., and favorable crystal orientation may be achieved when the film thickness is in a range from about 1 nm to about 4 nm.

The first interlayer 14 is formed to enhance the crystal orientation of the recording layer 16 and also promotes the grain separation in the recording layer 16. Specifically, it is possible to use Ru or a Ru alloy forming an hcp structure in which an element selected from Cr, Ta, W, Mo, Nb, Co, etc., is added to Ru. Changing the formation conditions and changing the materials can accommodate both the crystal orientation and the grain separation in the methods disclosed herein. Specifically, one formation technique may include forming the layer under a possible low gas pressure at the start of film formation with the aim of enhancing the crystal orientation, and immediately before the end of film formation raising the gas pressure for the purposes of grain separation, or it is equally feasible to produce a two-stage structure or three-stage structure under conditions in which the gas pressure and materials are varied. Low gas pressure refers specifically to about 1 Pa or less. High gas pressure refers to a range between about 2 Pa and about 6 Pa, and when this range is adopted, the surface roughness of the Ru is increased and voids are formed at the grain boundary. The film thickness is preferably in a range from about 8 nm to about 20 nm, in one approach. If it is less than about 8 nm, the crystal orientation deteriorates, while if it is greater than about 20 nm, the distance between the magnetic head and the soft magnetic underlayer increases, and therefore writeability deteriorates.

The second interlayer 15 is formed to promote grain separation of the recording layer 16. Specifically, it is possible to use a Ru alloy in which an element selected from Ti, Ta, Nb, Al, Si, etc., is added to Ru, in one approach. It is also possible to use a Ru alloy in which some of the elements added are in oxide form, in one approach. In the ferromagnetic metal layer 17, at least one element selected from B, Ta, Ru, Ti, W, Mo, Nb, Ni, Mn is preferably added, in one approach, with CoCrPt as a main component. There is no particular restriction as to the respective compositions and film thicknesses, provided that they can be adjusted to suit the film thickness of the soft magnetic underlayer and the magnetic head performance, and they are in a range allowing the thermal stability to be maintained.

The overcoat layer 18 may preferably be formed using a film having carbon as a main component at a thickness of between about 2 nm and about 5 nm, in one approach, such as a carbon overcoat. Furthermore, the lubricant layer 19 preferably makes use of a lubricant such as perfluoroalkyl polyether. This makes it possible to obtain a highly reliable magnetic recording medium.

According to one embodiment, it is possible to maintain thermal stability in a perpendicular magnetic recording medium and to reduce the film thickness of the recording layer, and therefore the resolution and SNR can be improved. A perpendicular magnetic recording medium exhibiting high resolution and high SNR is essential for increasing recording density, and by using this kind of perpendicular magnetic recording medium it is possible to provide a compact and high-capacity magnetic recording device.

In one embodiment, a perpendicular magnetic recording medium as described above in any embodiment may have a first granular recording layer including a first CoCrPt alloy in a first ratio (X₁) defined as a concentration of Pt divided by a concentration of Cr in the first CoCrPt alloy, a second granular recording layer including a second CoCrPt alloy in a second ratio (X₂), defined as a concentration of Pt divided by a concentration of Cr in the second CoCrPt alloy and a third granular recording layer including a third CoCrPt alloy in a third ratio (X₃), defined as a concentration of Pt divided by a concentration of Cr in the third CoCrPt alloy. Furthermore, in this embodiment, the respective ratios may be mathematically related such that X₃<X₂>X₁, and further still, in some approaches, the respective ratios may be mathematically related such that X₃<X₁.

In another arrangement, the perpendicular magnetic recording medium as described above may exhibit a Cr concentration in the first granular recording layer between about 18 at. % and about 30 at. %, between about 21 at. % and about 27 at. %, between about 20 at. % and about 25 at. %, etc.

According to one embodiment, a magnetic data storage system may include at least one magnetic head, a perpendicular magnetic recording medium as described according to any embodiment herein, a drive mechanism for passing the perpendicular magnetic recording medium over the magnetic head(s) and a controller electrically coupled to the magnetic head(s) and capable of controlling operation of the magnetic head(s).

Experimental Results

FIG. 1 schematically shows the cross section of a perpendicular magnetic recording medium constituting one exemplary embodiment (exemplary embodiment 1). The perpendicular magnetic recording medium in this exemplary embodiment was produced using a 200 LEAN sputtering apparatus produced by Intevac, Inc. All the chambers were exhausted as far as a vacuum of no more than about 2×10⁻⁵ Pa, after which a carrier on which a substrate was mounted was moved to each of the process chambers in order to carry out the processes in succession. The adhesion layer 11, soft magnetic underlayer 12, seed layer 13, first interlayer 14, second interlayer 15, granular recording layer 16, and ferromagnetic metal layer 17 were formed successively on the substrate 10 by using DC magnetron sputtering, and DLC (diamond-like carbon) was formed as the carbon overcoat 18. Finally, a lubricant in which a perfluoroalkyl polyether-based material had been diluted with a fluorocarbon material was applied as the liquid lubricant layer 19.

A glass substrate of thickness of about 0.8 nm and diameter about 65 nm was used as the substrate 10. Without heating the substrate, Ni-37.5Ta was formed to about 15 nm as the adhesion layer 11 under conditions of Ar gas pressure about 0.5 Pa, and the soft magnetic underlayer 12 was formed as two layers, namely a Co-28Fe-3Ta-5Zr alloy film of thickness about 20 nm, with the interposition of an Ru film of thickness about 0.4 nm under conditions of Ar gas pressure about 0.4 Pa. A Ni-14Fe-6W film of thickness about 7 nm was formed thereon as the seed layer 13. Ru of thickness about 4 nm was formed under conditions of Ar gas pressure about 0.5 Pa as the first interlayer 14, and also Ru of thickness about 5 nm was formed under conditions of Ar gas pressure about 3.3 Pa, and Ru of thickness about 5 nm was formed thereon under conditions of Ar gas pressure about 6.0 Pa. The second interlayer 15 was formed using an Ru-20Ti-10TiO₂ target under conditions of Ar gas pressure 4 Pa. The first granular recording layer, second granular recording layer, and third granular recording layer were all formed in different chambers. The first granular recording layer was formed under conditions of Ar gas pressure about 4 Pa and substrate bias about 200V using a [Co-18Cr-10.5Pt]-4SiO₂-2.5Co₃O₄ target, and the Pt concentration was raised to about 22.5 at. % in order to vary the Pt and Cr concentration ratio X₁. The film thickness was fixed at about 4 nm. The second granular recording layer was formed under conditions of Ar gas pressure about 4 Pa and substrate bias about 300V using a [Co-18Cr-22.5Pt]-4Si0₂-2.5Co₃O₄ target, and the Pt concentration was reduced to about 10.5 at. % in order to vary the Pt and Cr concentration ratio X₂. The film thickness was fixed at about 4 nm. The third granular recording layer was formed to a film thickness of about 4.5 nm under conditions of Ar gas [Co-26Cr-10.5Pt]-4SiO₂—Co₃O₄ pressure in the case of the layer was lower than that pressure about 0.9 Pa using a target. The Ar gas third granular recording of the other granular recording layers, which made it possible to improve the planarity of the medium surface. The film thickness and sputtering conditions in the case of the third granular recording layer were constant. The ferromagnetic metal layer 17 was formed to a film thickness of about 4 nm using a Co-15Cr-14Pt-8B target. A DLC film of thickness about 2.5 nm was formed as the overcoat layer 18. Finally, a polyether-based material lubricant in which a perfluoroalkyl had been diluted with a fluorocarbon material was applied as the lubricant layer 19.

TABLE 1

| | 1st granular recording layer | X1 | 2nd granular recording layer | X2 |
|---|---|---|---|---|
| Example 1-1 | 93.5[Co—18Cr—10.5Pt]—4SiO₂—2.5Co₃O₄ | 0.58 | 93.5[Co—18Cr—22.5Pt]—4SiO₂—2.5Co₃O₄ | 1.25 |
| Example 1-2 | 93.5[Co—18Cr—14.5Pt]—4SiO₂—2.5Co₃O₄ | 0.81 | 93.5[Co—18Cr—18.5Pt]—4SiO₂—2.5Co₃O₄ | 1.03 |
| Comp. Ex. 1-1 | 93.5[Co—18Cr—18.5Pt]—4SiO₂—2.5Co₃O₄ | 1.03 | 93.5[Co—18Cr—14.5Pt]—4SiO₂—2.5Co₃O₄ | 0.81 |
| Comp. Ex. 1-2 | 93.5[Co—18Cr—22.5Pt]—4SiO₂—2.5Co₃O₄ | 1.25 | 93.5[Co—18Cr—10.5Pt]—4SiO₂—2.5Co₃O₄ | 0.58 |

| | 3rd granular recording layer | X3 | (X1 + X2 + X3)/3 | Resolution (%) | KᵤV/K_{B}T |
|---|---|---|---|---|---|
| Example1-1 | 95[Co—26Cr—10.5Pt]—4SiO₂—1Co₃O₄ | 0.40 | 0.74 | 42.3 | 82 |
| Example1-2 | 95[Co—26Cr—10.5Pt]—4SiO₂—1Co₃O₄ | 0.40 | 0.74 | 42.2 | 80 |
| Comp. Ex. 1-1 | 95[Co—26Cr—10.5Pt]—4SiO₂—1Co₃O₄ | 0.40 | 0.74 | 42.2 | 70 |
| Comp. Ex. 1-2 | 95[Co—26Cr—10.5Pt]—4SiO₂—1Co₃O₄ | 0.40 | 0.74 | 42.1 | 69 |

Table 1 shows the target compositions of the first granular recording layer, second granular recording layer, and third granular recording layer in the samples produced; X₁, X₂ and X₃ at that time and the mean value thereof; resolution obtained by using read/write measurements; and KᵤV/K_{B}T.

Because the mean values of X₁, X₂, and X₃ changed, the magnetic anisotropy of the whole film also changed, the mean values of X₁, X₂ and X₃ were made the same for all samples. The read/write characteristics of the medium were evaluated by using a spin stand. The evaluation made use of a magnetic head comprising a writing element of single pole type which had a track width of about 70 nm, and a reading element having a track width of about 60 nm which employed tunnel magnetoresistance; the conditions for the evaluation were: circumferential speed about 10 m/sec, skew angle about 0°, and magnetic spacing approximately 8 nm. KᵤV/K_{B}T were measured by using a Kerr magnetometer. The field sweep rate (sweep rate) was varied at about 212 kA/(m·sec), about 106 kA/(m·sec), about 53 kA/(m·sec), about 27 kA/(m·sec) and about 13 kA/(m·sec). The Kerr loop was measured while a magnetic field was applied in the direction perpendicular to the film surface of the sample, and KᵤV/K_{B}T was obtained from the damping process of the coercive force (coercivity).

The method for evaluating KᵤV/K_{B}T is disclosed in the following document, for example, Quingzhi Peng and Hans J. Richter, “Field Sweep Rate Dependence of Media Dynamic Coercivity,” IEEE Trans. Magn., 40 (2004) 2446.

According to the results shown in Table 1, all of the samples have a constant film thickness, and therefore the resolution is largely unchanged, but KᵤV/K_{B}T increases with X. In particular, when X₁ is smaller than X₂, KᵤV/K_{B}T is clearly smaller, and the thermal stability deteriorates. Accordingly, when the mean values of X₁, X₂ and X₃ are compared under the same film thickness conditions, it is clear that the thermal stability improves when X₂ is set to be greater than X₁.

Here, samples in which the granular recording layer was formed as a single-layer structure to about 13 nm on the interlayer 15 were prepared in order to investigate the relationship of X and the magnetic anisotropy (Ku). The magnetic anisotropy was evaluated by the magnetic field angle dependence of the magnetic torque measured by using a torque magnetometer. The saturation magnetization Ms was measured by a vibrating sample magnetometer. The magnetic anisotropy was determined as the magnetic anisotropy on the inside of the magnetic grains. Also, the saturation magnetization was determined as the saturation magnetization on the inside of the magnetic grains. Specifically, the value obtained by subtracting the volume of the oxide content from the total film volume was taken as the volume of the magnetic grains contained in the film, and the magnetic anisotropy on the inside of the magnetic grains was obtained by using the volume of the magnetic grains.

TABLE 2

| | | X = |
|---|---|---|
| | Target composition | (Pt at. %)/(Cr at. %) |
| Example 1-5 | 93.5[Co—18Cr—10.5Pt]—4SiO₂—2.5Co₃O₄ | 0.58 |
| Example 1-6 | 93.5[Co—18Cr—14.5Pt]—4SiO₂—2.5Co₃O₄ | 0.81 |
| Example 1-7 | 93.5[Co—18Cr—18.5Pt]—4SiO₂—2.5Co₃O₄ | 1.03 |
| Example 1-8 | 93.5[Co—18Cr—22.5Pt]—4SiO₂—2.5Co₃O₄ | 1.25 |
| Example 1-9 | 95[Co—26Cr—5.5Pt]—4SiO₂—1Co₃O₄ | 0.21 |
| Example 1-10 | 95[Co—26Cr—10.5Pt]—4SiO₂—1Co₃O₄ | 0.40 |
| Example 1-11 | 95[Co—26Cr—14.5Pt]—4SiO₂—1Co₃O₄ | 0.56 |
| Example 1-12 | 95[Co—26Cr—18.5Pt]—4SiO₂—1Co₃O₄ | 0.71 |
| Example 1-13 | 95[Co—30Cr—10.5Pt]—4SiO₂—1Co₃O₄ | 0.35 |
| Example 1-14 | 91.5[Co—30Cr—18.5Pt]—6SiO₂—2.5Co₃O₄ | 0.62 |
| Example 1-15 | 93.5[Co—26Cr—22.5Pt]—4SiO₂—2.5Co₃O₄ | 0.87 |
| Example 1-16 | 88.5[Co—14.5Cr—18.5Pt]—5SiO₂—5TiO₂—1.5Co₃O₄ | 1.28 |
| Example 1-17 | 88.5[Co—14.5Cr—22.5Pt]—5SiO₂—5TiO₂—1.5Co₃O₄ | 1.55 |
| Example 1-18 | 88.5[Co—10.5Cr—18.5Pt]—5SiO₂—5TiO₂—1.5Co₃O₄ | 1.76 |
| Example 1-19 | 88.5[Co—10.5Cr—22.5Pt]—5SiO₂—5TiO₂—1.5Co₃O₄ | 2.14 |
| Example 1-20 | 88.5[Co—10.5Cr—25Pt]—5SiO₂—5TiO₂—1.5Co₃O₄ | 2.38 |

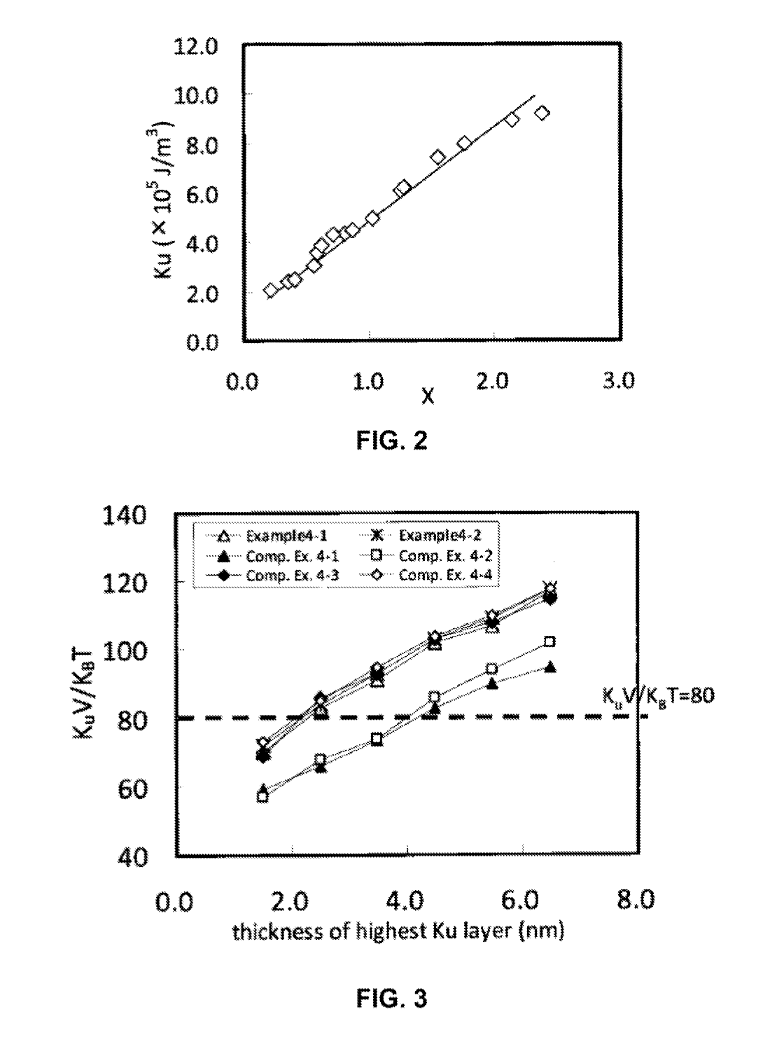

When the abovementioned measurements were also carried out for the alloy compositions shown in Table 2, the relationship between X and Ku on the inside of the magnetic grains was as shown in FIG. 2. It is clear from FIG. 2 that when X increases, Ku increases concurrently. It is therefore clear that Expression 1 and Expression 3 are equivalent.

From the above, the results in Table 1 show that when the mean values of Ku₁, Ku₂, and Ku₃ are compared under the same film thickness conditions, the thermal stability is improved by setting Ku₁ to be greater than Ku₂ regardless of whether the mean values of Ku₁, Ku₂, Ku₃ and the total film thickness are the same.

The perpendicular magnetic recording medium according to another exemplary embodiment (exemplary embodiment 2) was prepared using the same process as in exemplary embodiment 1, except for the granular recording layer 16. The first granular recording layer was formed to a film thickness of about 3 nm under conditions of Ar gas pressure about 4 Pa and substrate bias about 200V using a [Co-26Cr-18.5Pt]-4SiO₂-2.5Co₃O₄ target. The second granular recording layer was formed under conditions of Ar gas pressure 4 Pa and substrate bias about 300V using a [Co-18Cr-22.5Pt]-4SiO₂-2.5Co₃O target, and the Pt concentration was reduced to about 10.5 at. % in order to vary the Pt and Cr concentration ratio X₂. The film thickness was fixed at 4 nm. The third granular recording layer was formed under conditions of Ar gas pressure about 0.9 Pa using a [Co-26Cr-10.5Pt]-4SiO₂—Co₃O₄ target, and the Pt concentration was raised to about 22.5 at. % in order to vary the Pt and Cr concentration ratio X₃. The film thickness was fixed at 4 nm. The film thickness and sputtering conditions in the case of the first granular recording layer were constant, using the above samples, the magnetic characteristics and the read/write characteristics were investigated for when the mean values of X₂ and X₃ are constant and X₂ and X₃ are varied. The methods for evaluating the magnetic characteristics and the read/write characteristics of the medium are the same as in the previous exemplary embodiment.

TABLE 3

| | 1st granular recording layer | X1 | 2nd granular recording layer | X2 |
|---|---|---|---|---|
| Example2-1 | 93.5[Co—26Cr—18.5Pt]—4SiO₂—2.5Co₃O₄ | 0.71 | 93.5[Co—18Cr—22.5Pt]—4SiO₂—2.5Co₃O₄ | 1.25 |
| Example2-2 | 93.5[Co—26Cr—18.5Pt]—4SiO₂—2.5Co₃O₄ | 0.71 | 93.5[Co—18Cr—18.5Pt]—4SiO₂—2.5Co₃O₄ | 1.03 |
| Comp. Ex. 2-1 | 93.5[Co—26Cr—18.5Pt]—4SiO₂—2.5Co₃O₄ | 0.71 | 93.5[Co—18Cr—14.5Pt]—4SiO₂—2.5Co₃O₄ | 0.81 |
| Comp. Ex. 2-2 | 93.5[Co—26Cr—18.5Pt]—4SiO₂—2.5Co₃O₄ | 0.71 | 93.5[Co—18Cr—10.5Pt]—4SiO₂—2.5Co₃O₄ | 0.58 |

| | 3rd granular recording layer | X3 | (X1 + X2 + X3)/3 | Resolution (%) | OW (−dB) | KuV/KBT |
|---|---|---|---|---|---|---|
| Example2-1 | 95[Co—18Cr—10.5Pt]—4SiO₂—1Co₃O₄ | 0.58 | 0.85 | 40.6 | 32.2 | 85 |
| Example2-2 | 95[Co—18Cr—14.5Pt]—4SiO₂—1Co₃O₄ | 0.81 | 0.85 | 40.5 | 31.6 | 85 |
| Comp. Ex. 2-1 | 95[Co—18Cr—18.5Pt]—4SiO₂—1Co₃O₄ | 1.03 | 0.85 | 40.6 | 26.4 | 85 |
| Comp. Ex. 2-2 | 95[Co—18Cr—22.5Pt]—4SiO₂—1Co₃O₄ | 1.25 | 0.85 | 40.4 | 25.3 | 86 |

Table 3 shows the target compositions of the first granular recording layer, the second granular recording layer, and the third granular recording layer in the samples produced; X₁, X₂ and X₃ at that time and the mean value thereof; resolution and overwrite obtained by using read/write measurements. It should be noted that when the mean values of X₁, X₂, and X₃ changed, the magnetic anisotropy of the whole film also changed, and therefore the target compositions were selected in such a way that the mean values of X₁, X₂, and X₃ were the same for all the samples. According to the results shown in Table 3, in all of the samples the resolution and KuV/K_{B}T are largely unchanged, but overwrite becomes smaller the greater X₃. In particular, when X₃ is greater than X₂, overwrite deteriorates considerably, and hence the writeability deteriorates. When X₃ is greater than X₂, it is believed that the switching torque from the ferromagnetic metal layer 17 is no longer effectively transmitted to the granular recording layer below, and therefore the writeability deteriorates. X₃ therefore should be smaller than X₂ in order to achieve adequate writeability.

The perpendicular magnetic recording medium according to another exemplary embodiment (exemplary embodiment 3) was prepared using the same process as in exemplary embodiment 1, except for the granular recording layer 16. Three types of targets were prepared as the targets for the granular recording layer 16, namely [Co-26Cr-18.5Pt]-4SiO₂-2.5Co₃O₄, [Co-10.5Cr-22.5Pt]-5SiO₂-5TiO₂-1.5Co₃O₄, and [Co-26Cr-10.5Pt]-4SiO₂-1Co₃O₄, and as shown in Table 4, samples having different stacking orders were produced.

TABLE 4

| | 1st granular recording layer | X1 | 2nd granular recording layer | X2 |
|---|---|---|---|---|
| Example 4-1 | 93.5[Co—26Cr—18.5Pt]—4SiO₂—2.5Co₃O₄ | 0.71 | 88.5[Co—10.5Cr—22.5Pt]—5SiO₂—5TiO2—1.5Co₃O₄ | 2.14 |
| Example 4-2 | 95[Co—26Cr—10.5Pt]—4SiO₂—1Co₃O₄ | 0.40 | 88.5[Co—10.5Cr—22.5Pt]—5SiO₂—5TiO2—1.5Co₃O₄ | 2.14 |
| Comp. Ex. 4-1 | 88.5[Co—10.5Cr—22.5Pt]—5SiO₂—5TiO2—1.5Co₃O₄ | 2.14 | 93.5[Co—26Cr—18.5Pt]—4SiO₂—2.5Co₃O₄ | 0.71 |
| Comp. Ex. 4-2 | 88.5[Co—10.5Cr—22.5Pt]—5SiO₂—5TiO2—1.5Co₃O₄ | 2.14 | 95[Co—26Cr—10.5Pt]—4SiO₂—1Co₃O₄ | 0.40 |
| Comp. Ex. 4-3 | 95[Co—26Cr—10.5Pt]—4SiO₂—1Co₃O₄ | 0.40 | 93.5[Co—26Cr—18.5Pt]—4SiO₂—2.5Co₃O₄ | 0.71 |
| Comp. Ex. 4-4 | 93.5[Co—26Cr—18.5Pt]—4SiO₂—2.5Co₃O₄ | 0.71 | 95[Co—26Cr—10.5Pt]—4SiO₂—1Co₃O₄ | 0.40 |

| | 3rd granular recording layer | X3 |
|---|---|---|
| Example 4-1 | 95[Co—26Cr—10.5Pt]—4SiO₂—1Co₃O₄ | 0.40 |
| Example 4-2 | 93.5[Co—26Cr—18.5Pt]—4SiO₂—2.5Co₃O₄ | 0.71 |
| Comp. Ex. 4-1 | 95[Co—26Cr—10.5Pt]—4SiO₂—1Co₃O₄ | 0.40 |
| Comp. Ex. 4-2 | 93.5[Co—26Cr—18.5Pt]—4SiO₂—2.5Co₃O₄ | 0.71 |
| Comp. Ex. 4-3 | 88.5[Co—10.5Cr—22.5Pt]—5SiO₂—5TiO2—1.5Co₃O₄ | 2.14 |
| Comp. Ex. 4-4 | 88.5[Co—10.5Cr—22.5Pt]—5SiO₂—5TiO2—1.5Co₃O₄ | 2.14 |

Among these, [Co-10.5Cr-22.5Pt]-5SiO₂-5TiO₂-1.5Co₃O₄, which was the target composition in which Ku is the greatest (greatest X) was formed under conditions of Ar gas pressure about 4 Pa and substrate bias about 300V, and the film thickness was varied between about 1.5 nm and about 6.5 nm. [Co-26Cr-18.5Pt]-4SiO₂-2.5Co₃O₄, in which Ku was the second greatest (second greatest X), was formed under conditions of Ar gas pressure about 4 Pa and substrate bias about −200 V, and the film thickness was fixed at about 3 nm. [Co-26Cr-10.5Pt]-4SiO₂-1Co₃O₄, which had the smallest Ku (smallest X) among the granular layers, was formed under conditions of Ar gas pressure about 0.9 Pa, and the film thickness was fixed at about 4.5 nm. Examples 4-1 and 4-2 relate to perpendicular magnetic recording media which have a structure that satisfies the abovementioned Expression 1 and exhibit the features of this embodiment. The comparative samples cover all the combinations having a stacked structure which does not conform to the abovementioned Expression 1 when the materials are fixed and only the stacking order is changed.

Using the above samples, the magnetic characteristics read/write characteristics were evaluated and the superiority of the samples having a structure which satisfies the abovementioned Expression 1 was confirmed. The methods for evaluating the magnetic characteristics and the read/write characteristics of the medium are the same as in exemplary embodiment 1.

FIG. 3 shows the value of KuV/K_{B}T for each sample when the film thickness of the layer in which Ku is the greatest is varied. When the film thickness of a layer having the greatest Ku is increased, it is clear that KuV/K_{B}T increases and the thermal stability is improved. Furthermore, when compared at the same film thickness, it is clear that the thermal stability deteriorated in Comparative Ex. 4-1 and Comparative Ex. 4-2. The structure in Comparative Ex. 4-1 is the same structure as in many perpendicular magnetic recording media currently on the market, which have a structure in which the layer in which Ku is the greatest is the bottom-most layer and Ku becomes smaller moving toward the upper layer. KuV/K_{B}T generally has to be at least about 80 in order to satisfy the thermal stability of the perpendicular magnetic recording medium. It is clear that in order for KuV/K_{B}T to reach about 80, it would be necessary to make the thickness of the layer in which Ku is the greatest at least 4.5 nm in Comparative Ex. 4-1 and Comparative Ex. 4-2, and the film thickness of the layer in which Ku is the greatest should be at least about 2.5 nm in Example 4-1. It is therefore clear that Examples 4-1, 4-2 in which the second granular recording layer is the layer in which Ku is the greatest make it possible to reduce the film thickness by around about 2 nm, while still maintaining thermal stability, compared with Comparative Ex. 4-1 and Comparative Ex. 4-2. It can therefore be said that the trend of thermal stability and recording layer film thickness is improved in 4-2.

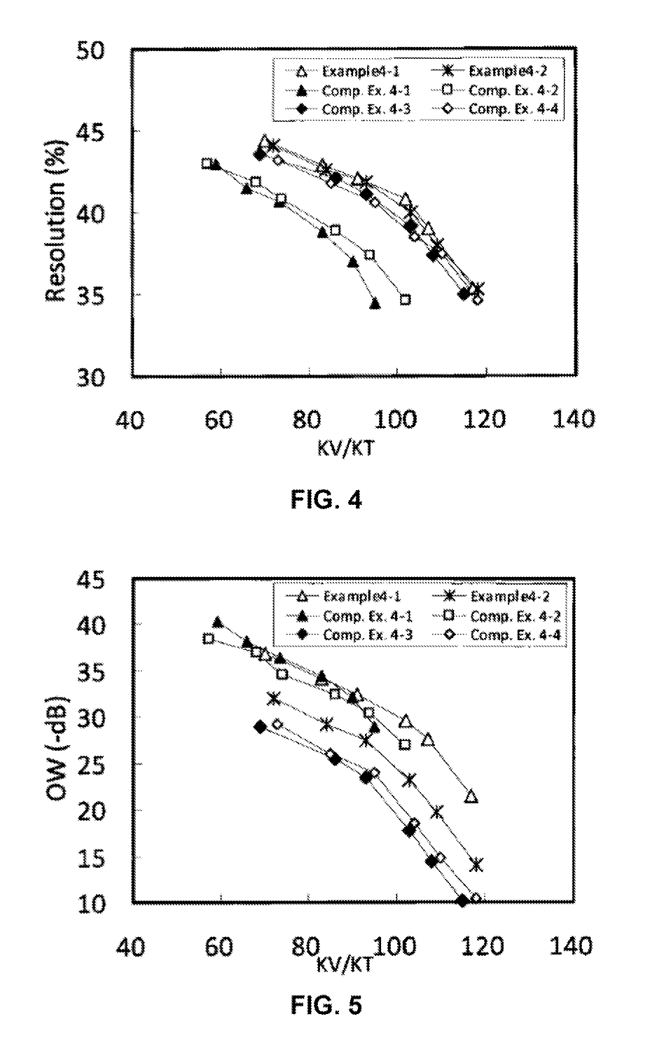

FIG. 4 shows KuV/K_{B}T on the horizontal resolution on the vertical axis. If a comparison is made at the same value for KuV/K_{B}T, an improvement in the resolution of approximately 3 points can be seen for Examples 4-1 and 4-2 compared with Comparative Ex. 4-1 and Comparative Ex. 4-2.

The trend of thermal stability and resolution in Comparative Ex. 4-3, 4-4 is equivalent to that of Examples 4-1, 4-2, and at a glance Comparative Ex. 4-3, 4-4 show that adequate performance is achieved. However, as shown in FIG. 5, the overwrite characteristics with respect to the same value of KuV/K_{B}T are poorer in Comparative Ex. 4-3, 4-4 compared with Examples 4-1, 4-2, and it can be said that the thermal stability and writeability trend deteriorates.

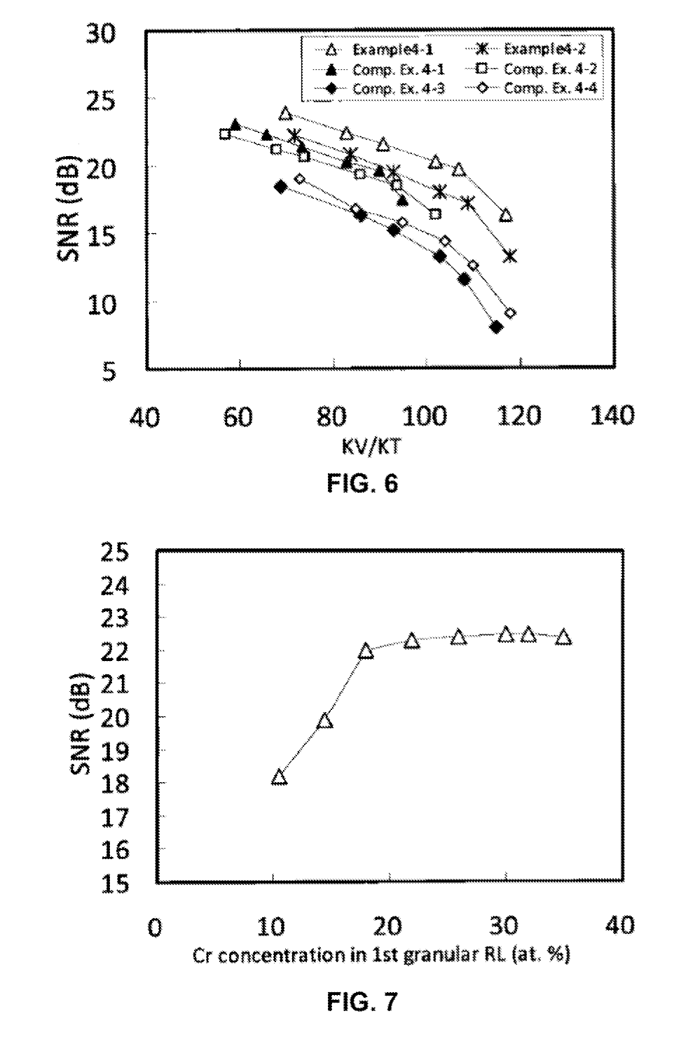

The results in FIG. 6 are SNR results for KuV/K_{B}T in each sample. If a comparison is made at the same KuV/K_{B}T, the SNR is higher in Examples 4-1 and 4-2 than in any of the comparative samples. Furthermore, if Examples 4-1 and 4-2 are compared, the SNR is higher for the same thermal stability in Example 4-1. It is therefore clear that it is more preferable for the layer in which Ku is lowest to be placed at the third granular recording layer.

To summarize the above, the trend of thermal stability and resolution is improved in Examples 4-1, 4-2 in contrast to Comparative Ex. 4-1, 4-2, and the trend of thermal stability and writeability, and thermal stability and SNR is improved in contrast to Comparative Ex. 4-3, 4-4, and therefore it is clear that these media structures are suitable for increasing density.

A perpendicular magnetic recording medium according to another exemplary embodiment (exemplary embodiment 4) was prepared using the same process as in exemplary embodiment 1, except for the granular recording layer 16.

TABLE 5

| | | Cr |
|---|---|---|
| | | concen- |
| | | tration |
| | 1st granular recording layer | (at. %) |
| Example 5-1 | 93.5[Co—35Cr—18.5Pt]—4SiO₂—2.5Co₃O₄ | 35.0 |
| Example 5-2 | 93.5[Co—32Cr—18.5Pt]—4SiO₂—2.5Co₃O₄ | 32.0 |
| Example 5-3 | 93.5[Co—30Cr—18.5Pt]—4SiO₂—2.5Co₃O₄ | 30.0 |
| Example 5-4 | 93.5[Co—26Cr—18.5Pt]—4SiO₂—2.5Co₃O₄ | 26.0 |
| Example 5-5 | 93.5[Co—22Cr—18.5Pt]—4SiO₂—2.5Co₃O₄ | 22.0 |
| Example 5-6 | 93.5[Co—18Cr—18.5Pt]—4SiO₂—2.5Co₃O₄ | 18.0 |
| Example 5-7 | 93.5[Co—14.5Cr—18.5Pt]—4SiO₂—2.5Co₃O₄ | 14.5 |
| Example 5-8 | 93.5[Co—10.5Cr—18.5Pt]—4SiO₂—2.5Co₃O₄ | 10.5 |

The first granular recording layer was formed to a film thickness of about 3 nm using several targets in which the Cr concentrations were varied to those shown in Table 5, under conditions of Ar gas pressure 4 Pa and substrate bias about 200V. The second granular recording layer was formed to a film thickness of about 2.5 nm under conditions of Ar gas pressure about 4 Pa and substrate bias about −300V, using a [Co-10.5Cr-22.5Pt]-5SiO₂-5TiO₂-1.5Co₃O₄ target. The third granular recording layer was formed to a film thickness of about 4.5 nm under conditions of Ar gas pressure about 0.9 Pa, using a [Co-26Cr-10.5Pt]-4SiO₂-1Co₃O₄ target.

Using the above samples, changes in KuV/K_{B}T and SNR with respect to changes in Cr concentration in the first granular recording layer were investigated. The methods for evaluating the magnetic characteristics and the read/write characteristics of the medium are the same as in exemplary embodiment 1.

FIG. 7 shows changes in SNR with respect to changes in Cr concentration in the first granular recording layer. When the Cr concentration is about 18 at. % or greater, a sufficiently high SNR is apparent, but when the Cr concentration is less than about 18 at. %, the SNR drops sharply. It is believed that when the Cr concentration is below about 18 at. %, the magnetic grains are magnetically coupled and therefore the noise increases.

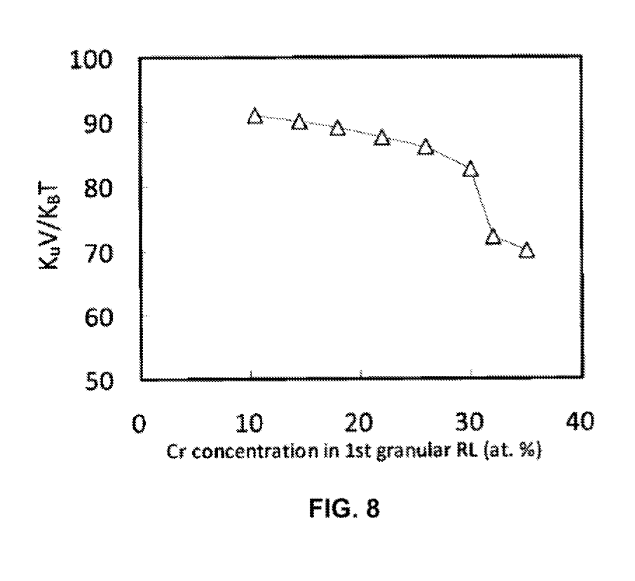

On the other hand, it is clear from the results of KuV/K_{B}T in FIG. 8 that when the Cr concentration is about 32 at. % or greater the thermal stability deteriorates sharply. It is believed that when the Cr concentration is about 32 at. % or greater the magnetic anisotropy and saturation magnetization decrease sharply and magnetism is no longer appeared, and therefore the effective volume of the recording layer is reduced, so the thermal stability deteriorates. From the above SNR and KuV/K_{B}T results it is clear that the Cr concentration in the first granular recording layer should be between about 18 at. % and about 30 at. %

A perpendicular magnetic recording medium according to another exemplary embodiment (exemplary embodiment 5) was prepared using the same process as in exemplary embodiment 1, except for the granular recording layer 16. The first granular recording layer was formed under conditions of Ar gas pressure 4 Pa and substrate bias about 200V. The second granular recording layer was formed under conditions of Ar gas pressure about 4 Pa and substrate bias about 300V. The third granular recording layer was formed under conditions of Ar gas pressure about 0.9 Pa. The target compositions and film thicknesses used to form each of the granular recording layers are shown in Table 6.

TABLE 6

| | | thick- | | |
|---|---|---|---|---|
| | | ness | | thick- |
| | | of | | ness |
| | | 1st | | of |
| | | gran- | | 2nd |
| | | ular | | gran- |
| | | re- | | ular |
| | | cord- | | record- |
| | | ing | | ing |
| | | layer | | layer |
| | 1st granular recording layer | (nm) | 2nd granular recording layer | (nm) |
| Exam- | 93.5[Co—26Cr—18.5Pt]—4SiO₂—2.5Co₃O₄ | 3.0 | 88.5[Co—10.5Cr—22.5Pt]—4SiO₂—4TiO2—2B₂O₃—1.5Co₃O₄ | 3.5 |
| ple 6-1 | | | | |
| Exam- | 93.5[Co—26Cr—18.5Pt]—4SiO₂—2.5Co₃O₄ | 3.0 | 88.5[Co—10.5Cr—22.5Pt]—2SiO₂—2TiO2—2B₂O₃—1.5Co₃O [symbol] | 3.5 |
| ple 6-2 | | | | |
| Exam- | 93.5[Co—26Cr—18.5Pt]—4SiO₂—2.5Co₃O₄ | 3.0 | 88.5[Co—10.5Cr—22.5Pt]—5SiO₂—5TiO2—1.5Co₃O [symbol] | 3.5 |
| ple 6-3 | | | | |
| Exam- | 93.5[Co—26Cr—18.5Pt]—4SiO₂—2.5Co₃O₄ | 3.0 | 88.5[Co—10.5Cr—22.5Pt]—5SiO₂ [symbol] 5TiO2—1.5Co₃O [symbol] | 3.5 |
| ple 6-4 | | | | |
| Exam- | 93.5[Co—26Cr—18.5Pt]—4SiO₂—2.5Co₃O₄ | 3.0 | 88.5[Co—10.5Cr—22.5Pt—5Ru]—4SiO₂—4TiO₂—1.5Co₃O₄ | 3.5 |
| ple 6-5 | | | | |
| Exam- | 93.5[Co—26Cr—18.5Pt]—4SiO₂—2.5Co₃O₄ | 3.0 | 88.5[Co—10.5Cr—22.5Pt—2B]—4SiO₂—4TiO₂—1.5Co₃O₄ | 3.5 |
| ple 6-6 | | | | |
| Exam- | 93.5[Co—26Cr—18.5Pt]—4SiO₂—2.5Co₃O₄ | 3.0 | 88.5[Co—10.5Cr—22.5Pt]—3SiO [symbol] —3TiO₂—2T [symbol] [symbol] O [symbol] —1.5Co₃O₄ | 3.5 |
| ple 6-7 | | | | |
| Exam- | 93.5[Co—26Cr—18.5Pt]—4SiO₂—2.5Co₃O₄ | 3.0 | 88.5[Co—10.5Cr—22.5Pt]—3SiO₂—3TiO₂—2WO₂—1.5Co₃O₄ | 3.5 |
| ple 6-8 | | | | |
| Exam- | 93.5[Co—26Cr—18.5Pt]—2SiO₂—2TiO₂—2.5Co₃O₄ | 3.0 | 88.5[Co—10.5Cr—22.5Pt]—5SiO₂—5TiO2—1.5Co₃O₄ | 3.5 |
| ple 6-9 | | | | |
| Exam- | 93.5[Co—26Cr—18.5Pt]—2SiO₂—2.5Co₃O₄ | 3.0 | 88.5[Co—10.5Cr—22.5Pt—5Ru]—4SiO₂—4TiO2—1.5Co₃O₄ | 3.5 |
| ple 6-10 | | | | |
| Exam- | 93.5[Co—26Cr—18.5Pt]—2SiO₂—2Cr2O3—2.5Co₃O₄ | 3.0 | 88.5[Co—10.5Cr—22.5Pt]—5SiO₂—5TiO2—1.5Co₃O₄ | 3.5 |
| ple 6-11 | | | | |
| Exam- | 93.5[Co—26Cr—18.5Pt—5Ru]—3SiO₂—2.5Co₃O₄ | 3.0 | 88.5[Co—10.5Cr—22.5Pt]—2SiO₂—2TiO2—2B₂O₃—1.5Co₃O₄ | 3.5 |
| ple 6-12 | | | | |
| Exam- | 93.5[Co—30Cr—18.5Pt]—6SiO₂—2.5Co₃O₄ | 1.0 | 88.5[Co—10.5Cr—22.5Pt]—2SiO₂—2TiO2—2B₂O₃—1.5Co₃O₄ | 4.5 |
| ple 6-13 | | | | |
| Exam- | 93.5[Co—30Cr—18.5Pt]—3SiO₂—3TiO₂—2.5Co₃O₄ | 1.0 | 88.5[Co—10.5Cr—22.5Pt]—2SiO₂—2TiO2—2B₂O₃—1.5Co₃O₄ | 4.5 |
| ple 6-14 | | | | |
| Exam- | 93.5[Co—26Cr—18.5Pt]—4SiO₂—2.5Co₃O₄ | 3.0 | 88.5[Co—10.5Cr—22.5Pt]—5SiO₂—5TiO2—1.5Co₃O₄ | 3.5 |
| ple 4-1 | | | | |
| Comp. | 88.5[Co—10.5Cr—22.5Pt]—5SiO₂—5TiO2—1.5Co₃O₄ | 3.0 | 93.5[Co—26Cr—18.5Pt]—4SiO₂—2.5Co₃O₄ | 5.5 |
| Ex. 4-1 | | | | |

| | | thickness of | | | | |
|---|---|---|---|---|---|---|
| | | 3rd granular | Resolution | OW | SNR | |
| | 3rd granular recording layer | recording layer (nm) | (%) | (−dB) | (dB) | KuV/KBT |
| Example 6-1 | 95[Co—26Cr—10.5Pt—5Ru]—4SiO₂—1Co₃O₄ | 4.5 | 42.0 | 32.4 | 22.5 | 91 |
| Example 6-2 | 95[Co—26Cr—10.5Pt—10Ru]—4SiO₂—1Co₃O₄ | 4.5 | 42.1 | 32.4 | 22.3 | 90 |
| Example 6-3 | 95[Co—26Cr—10.5Pt]—2SiO₂—2TiO₂—1Co₃O₄ | 4.5 | 42.2 | 32.4 | 22.3 | 92 |
| Example 6-4 | 95[Co—26Cr—10.5Pt—3B]—3SiO₂—1Co₃O₄ | 4.5 | 42.1 | 32.3 | 22.1 | 91 |
| Example 6-5 | 95[Co—26Cr—14.5Pt]—4SiO₂—1Co₃O₄ | 4.5 | 42.2 | 32.4 | 22.4 | 91 |
| Example 6-6 | 95[Co—26Cr—14.5Pt]—4SiO₂—1Co₃O₄ | 4.5 | 42.3 | 32.4 | 22.5 | 90 |
| Example 6-7 | 95[Co—26Cr—10.5Pt]—4SiO₂—1Co₃O₄ | 4.5 | 42.0 | 32.6 | 22.4 | 90 |
| Example 6-8 | 95[Co—26Cr—10.5Pt]—4SiO₂—1Co₃O₄ | 4.5 | 42.0 | 32.5 | 22.3 | 91 |
| Example 6-9 | 95[Co—26Cr—10.5Pt]—4SiO₂—1Co₃O₄ | 4.5 | 42.1 | 32.5 | 22.4 | 91 |
| Example 6-10 | 95[Co—26Cr—10.5Pt]—4SiO₂—1Co₃O₄ | 4.5 | 42.0 | 32.4 | 22.3 | 93 |
| Example 6-11 | 95[Co—26Cr—10.5Pt]—4SiO₂—1Co₃O₄ | 4.5 | 42.1 | 32.4 | 22.3 | 91 |
| Example 6-12 | 95[Co—26Cr—10.5Pt]—4SiO₂—1Co₃O₄ | 4.5 | 42.1 | 32.4 | 22.3 | 91 |
| Example 6-13 | 95[Co—26Cr—10.5Pt]—4SiO₂—1Co₃O₄ | 4.5 | 42.5 | 32.5 | 22.6 | 88 |
| Example 6-14 | 95[Co—26Cr—10.5Pt]—4SiO₂—1Co₃O₄ | 4.5 | 42.6 | 32.6 | 22.6 | 88 |
| Example 4-1 | 95[Co—26Cr—10.5Pt]—4SiO₂—1Co₃O₄ | 4.5 | 42.1 | 32.5 | 22.4 | 91 |
| Comp. Ex. 4-1 | 95[Co—26Cr—10.5Pt]—4SiO₂—1Co₃O₄ | 4.5 | 37.0 | 32.2 | 19.6 | 90 |

[symbol]

indicates data missing or illegible when filed

Table 6 includes the comparative samples used in exemplary embodiment 4 as a comparison. Using the above samples, the magnetic characteristics and read/write characteristics were investigated for when the oxide concentration is varied and for when additional elements are added to the CoCrPt alloy. As shown in Table 6, when additional elements are added to the CoCrPt alloy and when the oxide concentration is varied, it is clear that good resolution, overwrite and SNR are demonstrated while the thermal stability is maintained.

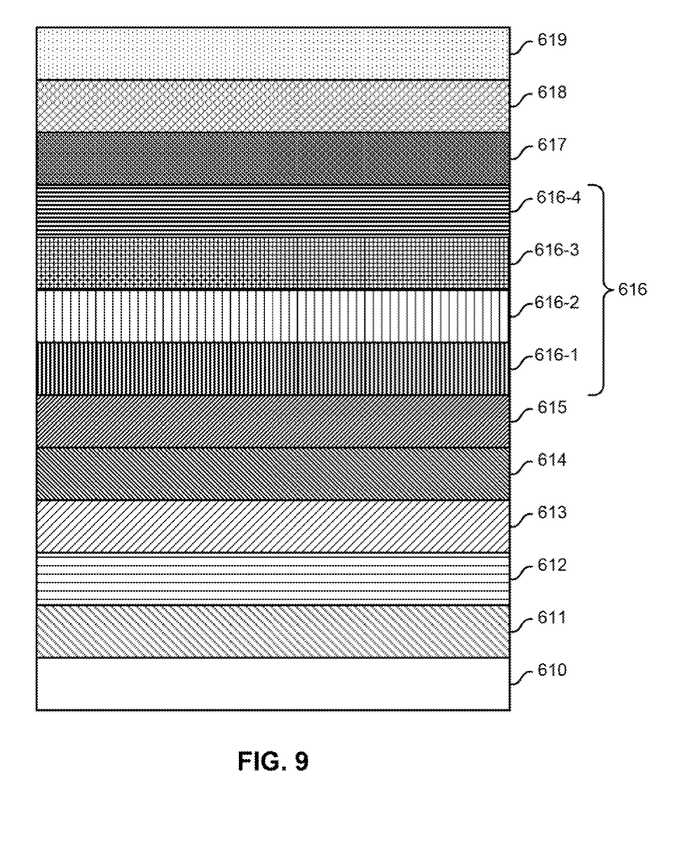

FIG. 9 schematically shows the cross section of a perpendicular magnetic recording medium according to another exemplary embodiment (exemplary embodiment 6). The perpendicular magnetic recording medium in this exemplary embodiment was produced using a 200 LEAN sputtering apparatus produced by Intevac, Inc. All the chambers were exhausted as far as a vacuum of no more than about 2×10⁻⁵ Pa, after which a carrier on which a substrate was mounted was moved to each of the process chambers in order to carry out the processes in succession. An adhesion layer 611, soft magnetic underlayer 612, seed layer 613, first interlayer 614, second interlayer 615, granular recording layer 616, and ferromagnetic metal layer 617 were formed successively on a substrate 610 by using DC magnetron sputtering, and DLC (diamond-like carbon) was formed as the overcoat layer 618. Finally, a lubricant in which a perfluoroalkyl polyether-based material had been diluted with a fluorocarbon material was applied as a liquid lubricant layer 619.

A glass substrate of thickness about 0.8 mm and diameter about 65 mm was used as the substrate 610, without heating the substrate, Ni-37.5Ta was formed to about 15 nm as the adhesion layer 611 under conditions of Ar gas pressure about 0.5 Pa, and the soft magnetic underlayer 612 was formed as two layers, namely a Co-28Fe-3Ta-5Zr alloy film of thickness about 20 nm, with the interposition of an Ru film of thickness about 0.4 nm under conditions of Ar gas pressure about 0.4 Pa. A Ni-14Fe-6W film of thickness about 7 nm was formed thereon as the seed layer 613. Ru of thickness 4 nm was formed under conditions of Ar gas pressure about 0.5 Pa as the first interlayer 614, and also Ru of thickness about 5 nm was formed under conditions of Ar gas pressure about 3.3 Pa, and Ru of thickness about 5 nm was formed thereon under conditions of Ar gas pressure about 6.0 Pa. The second interlayer 615 was formed using a Ru-20Ti-10TiO₂ target under conditions of Ar gas pressure about 4 Pa. The first granular recording layer 616-1, second granular recording layer 616-2, and third granular recording layer 616-4 were all formed in different chambers. The first granular recording layer was formed to a film thickness of about 3 nm under conditions of Ar gas pressure about 4 Pa and substrate bias about 200V using a [Co-26Cr-18.5Pt]-4SiO₂-2.5Co₃O₄ target. The second granular recording layer was formed to a thickness of about 2.5 nm under conditions of Ar gas pressure about 4 Pa and substrate bias −300V using a [Co-10.5Cr-22.5Pt]-5SiO₂-5SiO₂-1.5Co₃O₄ target. The third granular recording layer was formed to a film thickness of about 4.5 nm under conditions of Ar gas pressure about 0.9 Pa using a [Co-26Cr-10.5Pt]-4SiO₂-1Co₃O₄ target. The exchange coupling control layer 616-3 shown in Table 7 was formed between the second granular recording layer and the third granular recording layer for the purpose of controlling the exchange interactions of these layers. The exchange coupling control layer was formed to a thickness of 1 nm under conditions of Ar gas pressure about 4 Pa and substrate bias about 200 V.

In one approach, a soft magnetic underlayer 612 may be positioned below the first granular recording layer 616-1, a first interlayer 614 above the soft magnetic underlayer 612, a second interlayer 615 above the first interlayer 614, and a ferromagnetic metal layer 617 directly on or above the third granular recording layer 616-4. The ferromagnetic metal layer may be essentially free of oxides (of any type known in the art, within reasonable limitations) and the first granular recording layer, the second granular recording layer, and the third granular recording layer may each comprise an oxide, of any type known in the art and in concentrations as described herein according to various embodiments.

The read/write performance for the above samples was investigated using a head having a low field intensity. The medium overwrite characteristics were evaluated by using a spin stand. The evaluation made use of a head having a narrower track width and a lower field intensity than the head used in the exemplary embodiments above. Specifically, the evaluation made use of a magnetic head comprising a writing element of single pole type which had a track width of about 60 nm, and a reading element having a track width of about 55 nm which employed tunnel magnetoresistance; the conditions for the evaluation were: circumferential speed about 10 m/sec, skew angle about 0°, and magnetic spacing approximately 8.5 nm. The evaluation results are shown in Table 7.

TABLE 7

| | | Ms | | |
|---|---|---|---|---|
| | Coupling layer | (emu/cc) | Resolution (%) | OW (−dB) |
| Example 7-1 | 96[Co—30Cr—18Pt]—4SiO₂ | 197 | 40.3 | 34.2 |
| Example 7-2 | 96[Co—27Cr—18Pt]—4SiO₂ | 208 | 40.0 | 34.0 |
| Example 7-3 | 96[Co—25Cr—18Pt]—4SiO₂ | 296 | 40.0 | 32.7 |
| Example 7-4 | 96[Co—27Cr—10.5Pt—6B]—4SiO₂ | 168 | 40.1 | 34.6 |
| Example 7-5 | 96[Co—27Cr—18Pt—5Ni]—4SiO₂ | 200 | 40.1 | 34.0 |
| Example 7-6 | 96[Co—27Cr—18Pt—5Ru]—4SiO₂ | 180 | 40.4 | 34.4 |
| Example 7-7 | 96[Co—27Cr—18Pt]—4TiO₂ | 205 | 40.3 | 34.0 |
| Example 7-8 | 96[Co—27Cr—18Pt]—4B₂O₃ | 215 | 40.0 | 34.3 |
| Example 7-9 | 96[Co—40Cr—18Pt]—4SiO₂ | 0 | 40.0 | 34.1 |
| Comp. Ex. 7-1 | 96[Co—23Cr—18Pt]—4SiO₂ | 353 | 40.0 | 28.4 |
| Comp. Ex. 7-2 | 93.5[Co—18.5Cr—18.5Pt]—4SiO₂—2.5Co₃O₄ | 448 | 39.9 | 27.1 |
| Comp. Ex. 7-3 | 93.5[Co—18.5Cr—18.5Pt]—4SiO₂—2.5Co₃O₄ | 574 | 38.2 | 26.3 |
| Example 4-1 | — | — | 40.2 | 28.3 |

When the abovementioned head having a narrow track width was employed, the overwrite value of the medium produced in exemplary embodiment 4, Example 4-1, was no more than about 30 dB. As a general rule, in order to incorporate a perpendicular magnetic recording medium into a magnetic recording device, the overwrite characteristics are preferably at least about 30 dB. There is therefore a possibility that the medium produced in Exemplary Embodiment 4 will not perform adequately when it is used in combination with the abovementioned head having a low field intensity. On the other hand, the overwrite value improved with the perpendicular magnetic recording medium produced in this exemplary embodiment, which includes the exchange coupling control layer formed from a material having saturation magnetization of no more than about 300 emu/cc, and therefore the writeability is improved. This is believed to be because the presence of the exchange coupling control layer promotes the incoherent rotation mode. On the other hand, when an exchange coupling control layer formed from a material having saturation magnetization of greater than about 300 emu/cc is used, the writeability does not improve or deteriorates. This is believed to be because when the saturation magnetization of the exchange coupling control layer becomes excessively large, the exchange interactions between the second granular recording layer and the third granular recording layer become too strong, so the incoherent rotation mode is suppressed. It is clear from the above results that the magnitude of the exchange interactions between the second granular recording layer and the third granular recording layer should be suitably adjusted to match the head with which the medium is combined, and if the head field intensity is relatively small with respect to the switching field of the medium, an exchange coupling control layer formed from a material having saturation magnetization of no more than 300 emu/cc should be introduced.

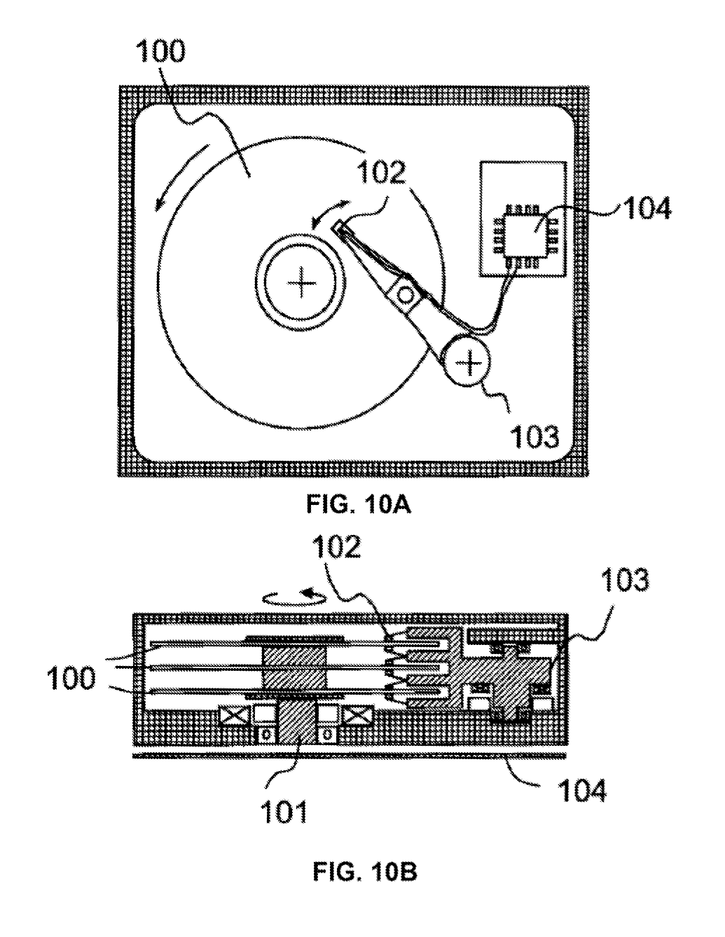

A magnetic recording device according to another embodiment is shown schematically in FIGS. 10A-10B, according to one embodiment. A magnetic recording medium 100 includes a medium according to one of the exemplary embodiments described above, and the magnetic recording device comprises a drive unit 101 for driving the medium, a magnetic head 102 comprising a recording section and a reproduction section, a mechanism 103 for moving the magnetic head 102 relative to the magnetic recording medium 100, and a mechanism 104 for inputting and outputting signals to the magnetic head 102.

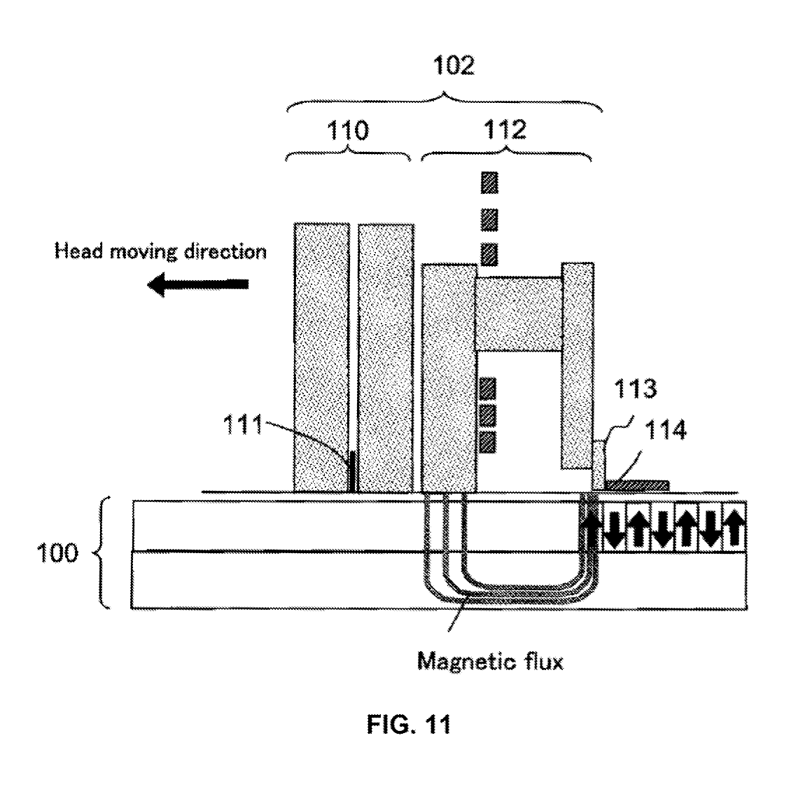

The relationship of the magnetic head 102 and the magnetic recording medium 100 is shown in FIG. 11, according to one embodiment. The distance between the magnetic head and the top of the medium (magnetic spacing) is set at about 7 nm in one approach, a tunnel magnetoresistive (TMR) element may be used for a reading element 111 in the reading section 110, and the head may be formed with a wraparound shield 114 around a magnetic main pole 113 of the writing section 112. By using the magnetic head 102 in which the shield is formed around the main magnetic pole of the writing section in this way, it is possible to improve the overwrite characteristics while maintaining a high medium SNR, and it is possible to confirm operation at about 121 gigabits per square centimeter (Gb/cm²) by setting the linear recording density per centimeter at about 728,000 bits, and the track density per centimeter at about. 167,000 tracks.

According to one embodiment, a magnetic data storage system may include at least one magnetic head, a perpendicular magnetic recording medium as described in any embodiment herein, a drive mechanism for passing the perpendicular magnetic recording medium over the magnetic head(s) and a controller electrically coupled to the magnetic head(s) and capable of controlling operation of the magnetic head(s).

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A perpendicular magnetic recording medium, comprising:
a first granular recording layer having a magnetic anisotropy (Ku₁);
a second granular recording layer above the first granular recording layer, the second granular recording layer having a magnetic anisotropy (Ku₂); and
a third granular recording layer above the second granular recording layer, the third granular recording layer having a magnetic anisotropy (Ku₃),
wherein Ku₃<Ku₂>Ku₁.

2. The perpendicular magnetic recording medium as recited in claim 1, wherein Ku₃<Ku₁.

3. The perpendicular magnetic recording medium as recited in claim 1, further comprising:
an interlayer below the first granular recording layer;
a soft magnetic underlayer below the interlayer; and
a ferromagnetic metal layer above the third granular recording layer.

4. The perpendicular magnetic recording medium as recited in claim 3, wherein the ferromagnetic metal layer is essentially free of oxides and is directly on the third granular recording layer, and wherein the first granular recording layer, the second granular recording layer, and the third granular recording layer each comprise an oxide.

5. A magnetic data storage system, comprising:
at least one magnetic head;
the perpendicular magnetic recording medium as recited in claim 1;
a drive mechanism for passing the perpendicular magnetic recording medium over the at least one magnetic head; and
a controller electrically coupled to the at least one magnetic head for controlling operation of the at least one magnetic head.

6. A perpendicular magnetic recording medium, comprising:
a first granular recording layer comprising a first CoCrPt alloy in a first ratio (X₁), wherein X₁ is defined by a concentration of Pt divided by a concentration of Cr in the first CoCrPt alloy;
a second granular recording layer above the first granular recording layer, the second granular recording layer comprising a second CoCrPt alloy in a second ratio (X₂), wherein X₂ is defined by a concentration of Pt divided by a concentration of Cr in the second CoCrPt alloy; and
a third granular recording layer above the second granular recording layer, the second granular recording layer comprising a third CoCrPt alloy in a third ratio (X₃), wherein X₃ is defined by a concentration of Pt divided by a concentration of Cr in the third CoCrPt alloy,
wherein X₃<X₂>X₁.

7. The perpendicular magnetic recording medium as recited in claim 6, wherein X₃<X₁.

8. The perpendicular magnetic recording medium as recited in claim 6, wherein the Cr concentration in the first granular recording layer is between about 18 at. % and about 30 at. %.

9. The perpendicular magnetic recording medium as recited in claim 6, further comprising:
an interlayer below the first granular recording layer;
a soft magnetic underlayer below the interlayer; and
a ferromagnetic metal layer directly on the third granular recording layer.

10. The perpendicular magnetic recording medium as recited in claim 9, wherein the interlayer comprises:
a first interlayer above the soft magnetic underlayer; and
a second interlayer above the first interlayer.

11. A magnetic data storage system, comprising:
at least one magnetic head;
the perpendicular magnetic recording medium as recited in claim 6;
a drive mechanism for passing the perpendicular magnetic recording medium over the at least one magnetic head; and
a controller electrically coupled to the at least one magnetic head for controlling operation of the at least one magnetic head.

12. A perpendicular magnetic recording medium, comprising:
a first granular recording layer;
a second granular recording layer above the first granular recording layer;
an exchange coupling control layer above the second granular recording layer; and
a third granular recording layer above the exchange coupling control layer,
wherein the exchange coupling control layer has a saturation magnetization of no greater than about 300 emu/cc.

13. The perpendicular magnetic recording medium as recited in claim 12, wherein a Cr concentration in the exchange coupling control layer is at least about 25 at. %.

14. The perpendicular magnetic recording medium as recited in claim 12,
wherein the first granular recording layer has a magnetic anisotropy (Ku₁), the second granular recording layer has a magnetic anisotropy (Ku₂), and the third granular recording layer has a magnetic anisotropy (Ku₃), and
wherein Ku₃<Ku₂>Ku₁.

15. The perpendicular magnetic recording medium as recited in claim 14, wherein Ku₃<Ku₁.

16. The perpendicular magnetic recording medium as recited in claim 12,
wherein the first granular recording layer comprises a first CoCrPt alloy in a first ratio (X₁), wherein X₁ is defined by a concentration of Pt divided by a concentration of Cr in the first CoCrPt alloy,
wherein the second granular recording layer comprises a second CoCrPt alloy in a second ratio (X₂), wherein X₂ is defined by a concentration of Pt divided by a concentration of Cr in the second CoCrPt alloy,
wherein the third granular recording layer comprises a third CoCrPt alloy in a third ratio (X₃), wherein X₃ is defined by a concentration of Pt divided by a concentration of Cr in the third CoCrPt alloy, and
wherein X₃<X₂>X₁.

17. The perpendicular magnetic recording medium as recited in claim 16, wherein X₃<X₁.

18. The perpendicular magnetic recording medium as recited in claim 12, wherein the Cr concentration in the first granular recording layer is between about 18 at. % and about 30 at. %.

19. The perpendicular magnetic recording medium as recited in claim 12, further comprising:
a soft magnetic underlayer below the first granular recording layer;
a first interlayer above the soft magnetic underlayer;
a second interlayer above the first interlayer; and
a ferromagnetic metal layer directly on the third granular recording layer,
wherein the ferromagnetic metal layer is essentially free of oxides and is directly on the third granular recording layer, and
wherein the first granular recording layer, the second granular recording layer, and the third granular recording layer each comprise an oxide.

20. A magnetic data storage system, comprising:
at least one magnetic head;
the perpendicular magnetic recording medium as recited in claim 12;
a drive mechanism for passing the perpendicular magnetic recording medium over the at least one magnetic head; and
a controller electrically coupled to the at least one magnetic head for controlling operation of the at least one magnetic head.
